(19) United States
(12) Patent Application Publication
(10) Pub. No.: US 2024/0330299 A1
(43) Pub. Date: Oct. 3, 2024

(54) Interwoven AMQ Data Structure

(71) Applicant: CrowdStrike, Inc., Irvine, CA (US)

(72) Inventor: Thomas Francis Lyons, Irvine, CA (US)

(73) Assignee: CrowdStrike, Inc., Irvine, CA (US)

(21) Appl. No.: 18/192,661

(22) Filed: Mar. 30, 2023

(51) Int. Cl. G06F 16/2455; G06F 16/22

(52) U.S. Cl. CPC G06F 16/24554; G06F 16/2237; G06F 16/435

(57) ABSTRACT

An interwoven approximate membership query (AMQ) data structure interweaves multiple AMQ data sets. The interwoven AMQ data structure collapses the AMQ data sets into a composite membership representation. The interwoven AMQ data structure still represents a computer database, but the interwoven AMQ data structure yields far faster membership results. The interwoven AMQ data structure requires orders of magnitude less data reads. Memory allocation is reduced, processor cycles are reduced, input/output operations are reduced, and translations from kernel space to user space are reduced. The interwoven AMQ data structure greatly improves computer functioning.

### BACKGROUND

The subject matter described herein generally relates to computers and, more particularly, the subject matter relates to membership testing of approximate membership query (or AMQ) data structures.

Searching data is hardware intensive. As cloud computing grows in usage, computer databases have grown exceptionally large. It is common, for example, for a cloud-distributed database to process and store ten million (10,000,000) messages per second. Because these exceptionally large databases must be searched, data lookups require much time and hardware resources.

### SUMMARY

A new and elegant approximate membership query (or AMQ) data structure greatly improves computer functioning. The interwoven AMQ data structure is generated by aggregating and interweaving multiple approximate membership query (or AMQ) data sets. The interwoven AMQ data structure thus represents a computer database or any other datastore, but the interwoven AMQ data structure is much smaller (in bytes) than its corresponding computer database. Moreover, the interwoven AMQ data structure is uniquely designed to yield far faster results in database searches and membership checks from multiple separate AMQ filters. So, when any computer needs to perform a search of the much larger computer database, the computer, instead, first conducts a preliminary membership test using the interwoven AMQ data structure. By interweaving bits of data from different AMQ data sets (such as Bloom filters), the interwoven AMQ data structure is a blend or composite of membership filter/bit traits. The interwoven AMQ data structure still represents the computer database, but the interwoven AMQ data structure consumes orders of magnitude less memory space. Because the interwoven AMQ data structure is much faster to search, the interwoven AMQ data structure requires orders of magnitude fewer data reads. In some examples, memory allocation is reduced, processor cycles are reduced, input/output operations are reduced, and translations from kernel space to user space are reduced. The interwoven AMQ data structure greatly improves computer functioning.

### BRIEF DESCRIPTION OF THE SEVERAL VIEWS OF THE DRAWINGS

The features, aspects, and advantages of cloud services malware detection are understood when the following Detailed Description is read with reference to the accompanying drawings, wherein:

FIG. 1 illustrates some examples of the interwoven AMQ data structure;

FIGS. 2-4 illustrate examples of membership testing the interwoven AMQ data structure;

FIG. 5 illustrates examples of byte level adaptations;

FIG. 6 illustrates a time-series of AMQ data sets;

FIG. 7 illustrates multiple versions of the interwoven AMQ data structure;

FIGS. 8-11 illustrate more bit level examples of the interwoven AMQ data structure;

FIG. 12 illustrates a method or flowchart for looking up a key using the interwoven AMQ data structure;

FIG. 13 illustrates examples of layering of filters;

FIG. 14 illustrates more examples of interwoven AMQ data structures;

FIGS. 15-16 illustrate examples of untimed interwoven Bloom filters;

FIG. 17 illustrates examples of a method or operations that improves computer functioning using the interwoven AMQ data structure;

FIG. 18 illustrates more examples of a method or operations for determining a membership associated with the interwoven AMQ data structure;

FIG. 19 illustrates still more examples of a method or operations for determining a membership associated with the key; and

FIG. 20 illustrates a more detailed example of the operating environment.

### DETAILED DESCRIPTION

Some examples relate to preliminary searches of computer databases. A computer database is stored within a server, a smartphone, or other computer. The computer database stores hundreds, thousands, millions, or more of electronic records (such as movies, music, messages, documents, or other electronic files). Whatever the electronic records, the computer database may thus be very large, especially in cloud computing environments. Because many databases are large, these large databases burden processors and memory. Large databases are slow to search, as the hardware processor and memory require more operations and more time. Large databases require more electrical power, as the hardware processor and memory consume more electricity when performing searches. Large databases also consume more memory/storage space, which further bogs down performance. As a general rule, then, as databases grow in size, their costs also grow.

Some examples relate to membership search schemes. The examples describe a new and elegant interwoven approximate membership query (or AMQ) data structure. This interwoven AMQ data structure is sometimes referred to herein as a “Lyons data structure.” The interwoven AMQ data structure can substantially reduce the burdens associated with any computer database or any other datastore. A computer is programmed to generate the interwoven AMQ data structure as a binary bit-set membership representation of the computer database. The interwoven AMQ data structure, though, is much smaller (in bytes) than its corresponding computer database. Moreover, the interwoven AMQ data structure is uniquely designed to yield far faster results in database searches. So, when any computer needs to perform a search of the computer database, the computer, instead, first conducts a preliminary membership test using the interwoven AMQ data structure, which can be much smaller than the computer database itself. The preliminary membership test reveals whether a data element is a member of the interwoven AMQ data structure. If the preliminary membership test is negative (i.e., the data element is not a member of the interwoven AMQ data structure), then the computer may immediately decline to search the larger computer database. That is, because the data element is not a member of the interwoven AMQ data structure, there is no need, reason, or advantage in searching the corresponding computer database. The computer, in other words, would waste time, energy, and cost searching the larger computer database. However, if the preliminary search is positive (i.e., the data element might be a member of the interwoven AMQ data structure), then the computer may perform a more thorough search of the larger computer database. In other words, because the preliminary membership test is satisfied, the time, energy, and cost of searching the larger computer database is justified. The interwoven AMQ data structure is thus designed to make a quick and simple go-no-go decision for a more expensive and resource-intensive search of the larger computer database.

The interwoven AMQ data structure can greatly improve computer functioning. The interwoven AMQ data structure (or the “Lyons data structure) is ingeniously designed to interweave different approximate membership query (or AMQ) data sets. While there are many different types of AMQ data sets, Bloom filters are well-known examples. The interwoven AMQ data structure may thus represent interwoven Bloom filters. The computer is programmed to identify and to read individual bits of data from within different Bloom filters. The computer is programmed to then elegantly interweave the bits of data to create an interwoven AMQ data structure. By interweaving the bits of data from different Bloom filters, the interwoven AMQ data structure is a blend or composite of membership bit-set filters or traits described by the different Bloom filters. The interwoven AMQ data structure still represents the computer database, but the interwoven AMQ data structure consumes orders of magnitude less memory space. Moreover, the interwoven AMQ data structure is much faster to search, perhaps requiring orders of magnitude less data reads. Memory allocation is reduced, processor cycles are reduced, input/output operations are reduced, and translations from kernel space to user space are reduced.

The design, construction, and usage of the interwoven AMQ data structure will now be described more fully hereinafter with reference to the accompanying drawings. The interwoven AMQ data structure, however, may be embodied in many different forms and should not be construed as limited to the examples set forth herein. These examples are provided so that this disclosure will be thorough and complete and fully convey the interwoven AMQ data structure to those of ordinary skill in the art. Moreover, all the examples of the interwoven AMQ data structure are intended to encompass both structural and functional equivalents thereof. Additionally, it is intended that such equivalents include both currently known equivalents as well as equivalents developed in the future (i.e., any elements developed that perform the same function, regardless of structure).

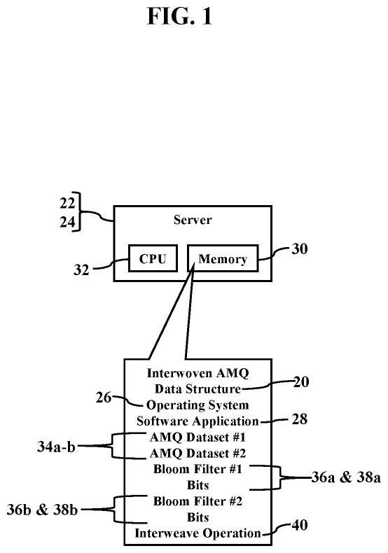

FIG. 1 illustrates some examples of the interwoven AMQ data structure 20. A computer system 22 is programmed to generate the interwoven AMQ data structure 20. The interwoven AMQ data structure 20 is sometimes referred to herein as a “Lyons data structure 20.” FIG. 1 illustrates the computer system 22 as a server 24, but the computer system 22 may be any processor-controlled device (as later paragraphs will explain). The server 24 stores and executes an operating system 26. The server 24 also stores a software application 28 in a memory device 30. The server 24 has a hardware processor 32 (illustrated as “CPU”) that reads and executes the software application 28. The software application 28 has programming code or instructions that cause the server 24 to perform operations, such as generating the interwoven AMQ data structure 20 using two (2) or more approximate membership query (AMQ) data sets (illustrated as reference numerals 34a and 34b). Again, while the interwoven AMQ data structure 20 may be generated using any bit-setting AMQ data structures, Bloom filters (illustrated as reference numerals 36a and 36b) are well-known examples of bit-setting AMQ data structures. The software application 28 instructs the hardware processor 32 to retrieve the Bloom filters 36a and 36b as inputs. While the Bloom filters 36a and 36b may be retrieved from any networked location, FIG. 1 simply illustrates local retrieval from the memory device 30.

The Lyons data structure 20 is elegantly created. The software application 28 instructs the hardware processor 32 to identify one or more binary bits 38a contained within, associated with, or representing the first Bloom filter 36a. The software application 28 instructs the hardware processor 32 to identify one or more binary bits 38b contained within, associated with, or representing the second Bloom filter 36b. The software application 28 instructs the hardware processor 32 to read or to retrieve the binary bits 38a and 38b from the memory device 30. Once the binary bits 38a and 38b are acquired, the software application 28 instructs the hardware processor 32 to aggregate the Bloom filters 36a-b. The hardware processor 32 performs an interweave operation 40 using the binary bits 38a and 38b. The hardware processor 32, executing the interweave operation 40, then generates the interwoven AMQ (or Lyons) data structure 20 as an output. The interweave operation 40 collapses and merges the multiple Bloom filters 36a and 36b into at least one interwoven AMQ data structure 20. By interweaving the binary bits 38a and 38b, the interwoven AMQ (or Lyons) data structure 20 represents a blend or composite of membership filters or bit traits represented by the different Bloom filters 36a and 36b. Once the interwoven AMQ data structure 20 is generated, the hardware processor 32 may then store the interwoven AMQ data structure 20 in the memory device 30.

The interwoven AMQ (or Lyons) data structure 20 collapses the two (2) Bloom filters 36a and 36b. Because there are only two (2) Bloom filters 36a-b in these simple examples, the interweave operation 40 may read each bit 38a-b and perform a bitwise OR operation. In other words, if the first bit 38a of Bloom filter 36a is zero (0), and the first bit 38b of Bloom filter 36b is one (1), then the interweave operation 40 may collapse bits 38a-b as a single bit value of one (1). Conversely, if both bits 38a-b were zero (0), then the bits 38a-b collapse to a bit value of zero (0). The interweave operation 40, however, may use any other bitwise operation to suit any objective. Similarly, the interwoven AMQ data structure 20 may also be generated using any bitwise operations to collapse bits 38 from multiple Bloom filters 36. The aggregated positional bits 38a-b from different Bloom filters 36a-b may be collapsed (such as using the OR operation) and the resultant value written to the interwoven AMQ data structure 20.

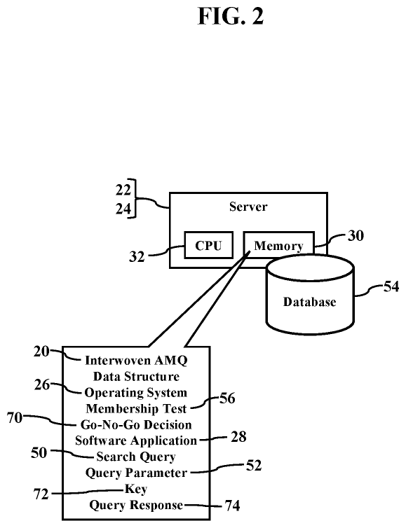

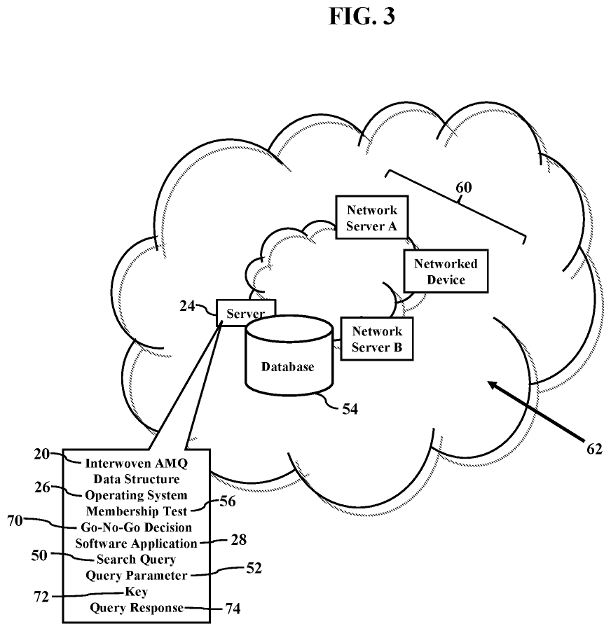

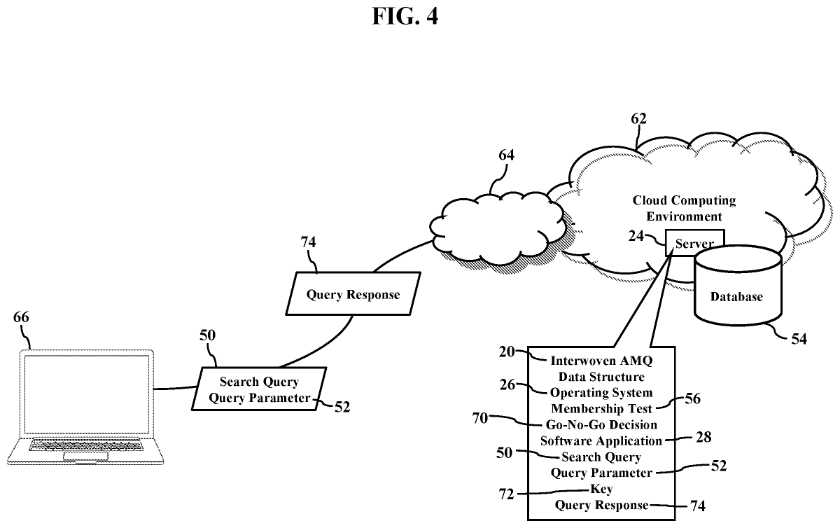

FIGS. 2-4 illustrate examples of membership testing the interwoven AMQ (or Lyons) data structure 20. The server 24 receives a search query 50. The search query 50 specifies a query parameter 52, and the search query 50 requests a search of a computer database 54. However, because the database search may be resource intensive and relatively expensive, the server 24 may first conduct a membership test 56 using the interwoven AMQ data structure 20. The interwoven AMQ (or Lyons) data structure 20 represents a blend or composite of membership filters or bit traits (as explained with reference to FIG. 1). The interwoven AMQ (or Lyons) data structure 20 may thus be stored as a data blob in the memory 30 (such as a database entry or in cache memory). The interwoven AMQ data structure 20 may also be stored as a series of bytes in the memory 30). The interwoven AMQ (or Lyons) data structure 20 may also be represented as a file on disk, a file over the network, the data blob, or the series of bytes. FIG. 2 illustrates an example of OS origination in which the search query 50 issues from the operating system 26. FIG. 3 illustrates an example of cloud origination in which the search query 50 issues from a network member 60 associated with a cloud computing environment 62. FIG. 4 illustrates an example of endpoint origination in which the search query 50 is received via a communications network 64 from a remote endpoint device 66. However the search query 50 is received, the search query 50 requests a search of the computer database 54 according to the query parameter 52. When the server 24 receives the search query 50, the server 24 may thus act as a query handler of client requests for searching the computer database 54. However, instead of a resource-intensive search of the computer database 54, the server 24 first conducts the membership test 56 using the interwoven AMQ (or Lyons) data structure 20. The membership test 56 may thus be a preliminary procedure based on the much smaller and nimble Lyons data structure 20.

The interwoven AMQ (or Lyons) data structure 20 is uniquely designed to consume far less computer resources and to yield far faster search results. The server 24 may thus be programmed to first conduct the membership test 56, based on the interwoven AMQ data structure 20, as a go-no-go decision 70. The server 24 conducts the membership test 56 based on the query parameter 52. However, because the interwoven AMQ data structure 20 aggregates and interweaves the Bloom filters 36a-b, the interwoven AMQ data structure 20 contains a composite membership representation of all the multiple Bloom filters 36a and 36b. The server 24 may thus conduct a single, simultaneous query (e.g., the membership test 56) of both Bloom filters 36a and 36b. In the simple examples illustrated by FIGS. 1-4, there are only two (2) Bloom filters 36a and 36b. The server 24 may thus execute the single membership test 56 that simultaneously inspects both Bloom filters 36a and 36b. A conventional membership scheme would require two (2) data lookups (e.g., one membership test for each Bloom filter). Yet, because of the ingenious interwoven AMQ data structure 20, the server 24 need only perform the single, simultaneous membership test 56, thus yielding a 50% reduction in processor reads. Indeed, in actual production use, there may be thousands or even millions of different Bloom filters 36. The server 24 may still aggregate and interweave these thousands or even millions of different Bloom filters 36 into the single interwoven AMQ (or Lyons) data structure 20. The server 24 still needs only to perform the single, simultaneous membership test 56, thus yielding an orders of magnitude reduction in hardware lookups. The reduction may be directly proportional to the number of AMQ filters represented by the interwoven AMQ (or Lyons) data structure 20, thus yielding orders of magnitude reductions in hardware lookups for large numbers of filters.

The examples of the interwoven AMQ (or Lyons) data structure 20 are continued. When the search query 50 is received, the server 24 may generate and/or retrieve a key 72 that represents the query parameter 52. While the key 72 may have any element form or value, the key 72 may be a cryptographic hash value. As a simple example, the query parameter 52 (specified by the search query 50) may be hashed by a hashing function to generate the cryptographic key 72. The key 72 represents the query parameter 52. However the key 72 is determined, the server 24 may then membership query or test the interwoven AMQ data structure 20 for a bit-set membership of the key 72. If the membership test 56 is negative (i.e., the key 72 is not a member of the interwoven AMQ data structure 20), then the server 24 may decline to search the computer database 54. That is, because the key 72 fails the membership test 56, the server 24 determines that the corresponding query parameter 52 will not be found in the larger computer database 54. The server 24 would thus waste time, energy, and cost conducting a fruitless search of the computer database 54 for the query parameter 52. However, if the membership test 56 is positive (i.e., the key 72 satisfies the membership test 56 and can be a member of the interwoven AMQ data structure 20), then the server 24 may perform a more thorough search of the larger computer database 54. The query parameter 52, in other words, could be found in the larger computer database 54, so the search time, energy, and cost are justified. The server 24 may then generate a query response 74. The query response 74 may indicate a result of the membership test 56 (such as whether the key 72 is the member of the interwoven AMQ data structure 20). The query response 74, in other words, may indicate that the query parameter 52 is not found in the computer database 54, based merely on the failed membership test 56. When, however, the membership test 56 is satisfied, the query response 74 may indicate a search result of the larger computer database 54. The interwoven AMQ (or Lyons) data structure 20 is thus designed to make the very quick and the very simple go-no-go decision 70 for a more expensive and resource-intensive search of the larger database 54.

The interwoven AMQ (or Lyons) data structure 20 can greatly improve computer functioning. The interwoven AMQ data structure 20 is ingeniously designed to interweave the multiple AMQ data sets 34a and 34b (illustrated in FIG. 1), thus collapsing and merging their bit contents into the single interwoven AMQ data structure 20. The binary bits 38a and 38b (illustrated in FIG. 1) are identified and read from the different AMQ data sets 34a-b. The server 24 executes the interweave operation 40 (illustrated in FIG. 1) that elegantly interweaves the bits 38a and 38b to create the interwoven AMQ data structure 20. Again, while there are many different types of bit-setting AMQ data sets, this disclosure mostly discusses and explains the examples using the Bloom filters 36a and 36b (illustrated in FIG. 1). The interwoven AMQ data structure 20 may thus represent interwoven Bloom filters 36a and 36b. The software application 28 causes the server 24 to identify and to read the individual bits 38a and 38b from within the different Bloom filters 36a and 36b. By interweaving the bits 38a and 38b from the different Bloom filters 36a and 36b, the interwoven AMQ data structure 20 blends their respective filters or membership bit traits to generate a comprehensive and more concise composite membership representation. The single interwoven AMQ data structure 20 consumes orders of magnitude less memory space for read operations, is much faster to search, and requires orders of magnitude less data reads. Memory allocation is reduced, processor cycles are reduced, input/output operations are reduced, and translations from kernel space to user space are reduced. The interwoven AMQ data structure 20 greatly improves computer functioning.

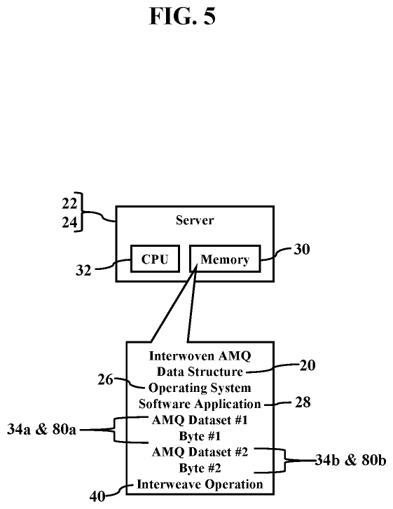

FIG. 5 illustrates examples of byte level adaptations. The above examples describe the interwoven AMQ (or Lyons) data structure 20 using bit level interweaving. The examples, however, may be easily adapted to byte level interweaving. The interweave operation 40, in other words, may interweave different bytes 80a-b of data read from the different approximate membership query (AMQ) data sets 34a-b. Again, because there are many different types of bit-setting AMQ data sets, the interwoven AMQ data structure 20 may be generated to represent any filters, such as Counting Bloom filters, Cuckoo filters, Xor filters, and Quotient filters, regardless of bit/byte size. The examples may be easily adapted to identify, read, and interweave bytes 80 of data selected from different AMQ data structures.

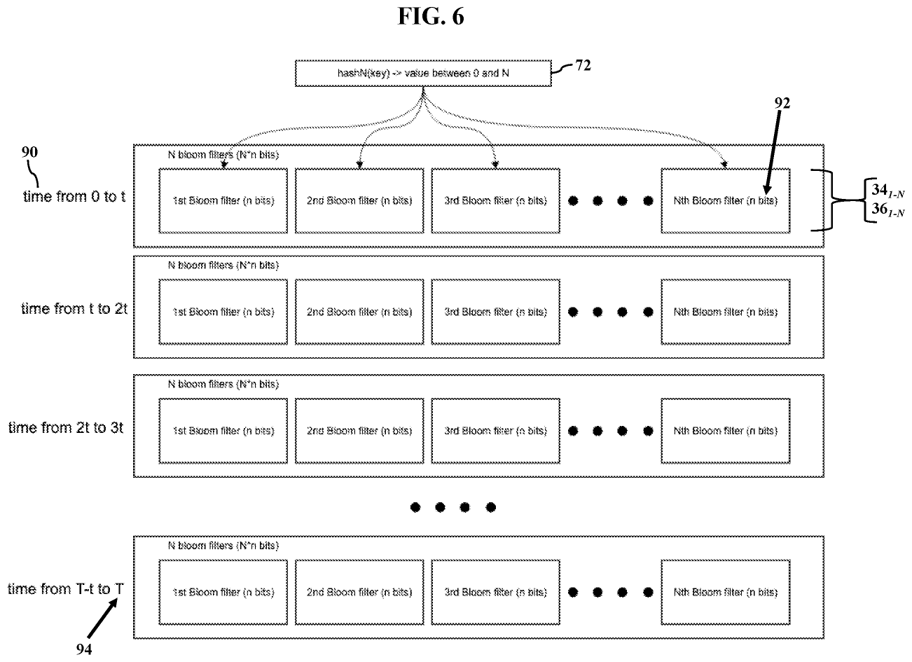

FIG. 6 illustrates a time-series of AMQ data sets 34. Again, while the examples may be applied to any bit-setting AMQ data structure, FIG. 6 illustrates a time-series of the Bloom filters 36. Each unit of time t (illustrated as reference numeral 90) is represented by N relatively small Bloom filters 36_{1-N}, where N is an integer value. Each Bloom filter 36_{1-N} has a bit length of n bits (illustrated as reference numeral 92) and their corresponding bit positions 0, 1, 2, . . . , n. When storing the key 72 to the Bloom filters 36_{1-N}, the key 72 may first be hashed to determine which Bloom filter 36_{1-N} in the time-series correlates to the key's hash value. The aggregate of multiple time units occurs over a fixed window T (illustrated as reference numeral 94). While the times-series of the Bloom filters 36_{1-N} may be generated using any interval of time, FIG. 6 illustrates the common example of daily filtering. That is, the Bloom filters 36_{1-N} are generated every minute (t=60 secs or 1 min) of every hour of every day (e.g., T=24 hours).

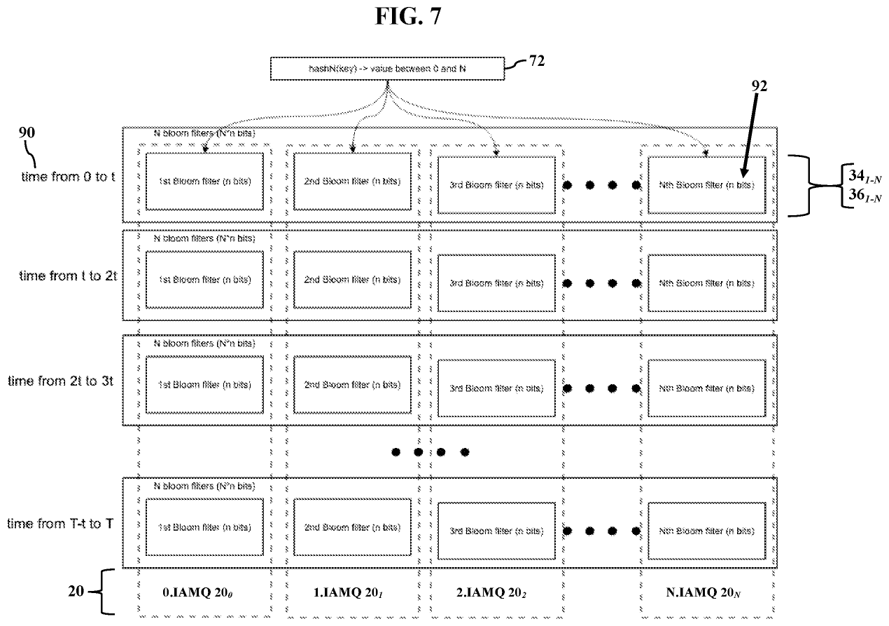

FIG. 7 illustrates multiple versions of the interwoven AMQ (or Lyons) data structure 20. All the Bloom filters 36 occurring within an aggregate window of time may be saved to the memory device 30 (illustrated in FIGS. 1-2) as A number of the interwoven AMQ data structures 20. Recall that each Bloom filter 36_{1-N} has the bit length of n bits and their corresponding bit positions 0, 1, 2, . . . , n. Each interwoven AMQ data structure 20 may thus represent a correspondingly single Bloom filter index. That is, interwoven AMQ data structure (or IAMQ) 200 represents the binary bits 38 within the Bloom filters 36 occurring at index 0 (e.g., bit position 0) from each Bloom filter 36_{1-N} at each unit of time. The IAMQ 20/represents the binary bits 38 within the Bloom filters 36 occurring at index 1 (such as bit position 1) from each unit of time. The IAMQ 202 represents the binary bits 38 within the Bloom filters 36 occurring at index 2 (such as bit position 2) from each unit of time. The IAMQ 20w represents the binary bits 38 within the Bloom filters 36 occurring at index N (such as bit position n) from each unit of time. The aggregate bits 38 may be sorted by bit index (e.g., bit positions 0, 1, 2, . . . , n), perhaps then by time unit, such that all of the bits 38 for a given bit index are aggregated and co-located with the interwoven AMQ data structure 20.

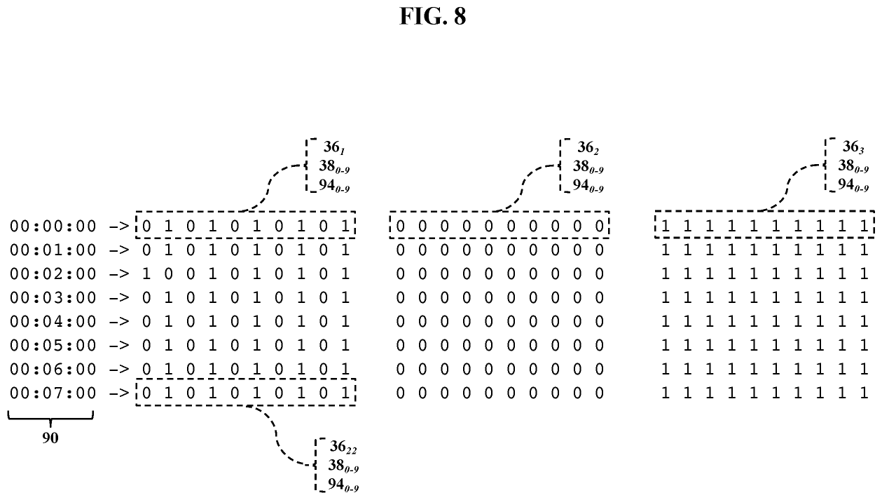

FIGS. 8-11 illustrate more bit level examples of the interwoven AMQ (or Lyons) data structure 20. FIG. 8 illustrates an example of simple Bloom filters 36 generated over eight (8) minutes. That is, let t=1 minute, T=8 minutes, and N=3. FIG. 8 thus illustrates three (3) Bloom filters 361-3 generated every sixty (60) seconds. Moreover, in these examples, the membership of each Bloom filter 361-3 is described using n=10 bits (illustrated as reference numeral 380-9). Because each Bloom filter 361-3 is represented with n=10 bits, each Bloom filter 367-3 has a corresponding ten (10) bit positions 0, 1, 2, . . . , 9 (illustrated as reference numeral 940-9). Again, FIGS. 8-11 illustrate simple examples. In actual practice, the Bloom filters 36 would have far more than ten (10) bits 380-9 and their corresponding ten (10) bit positions 940-9.

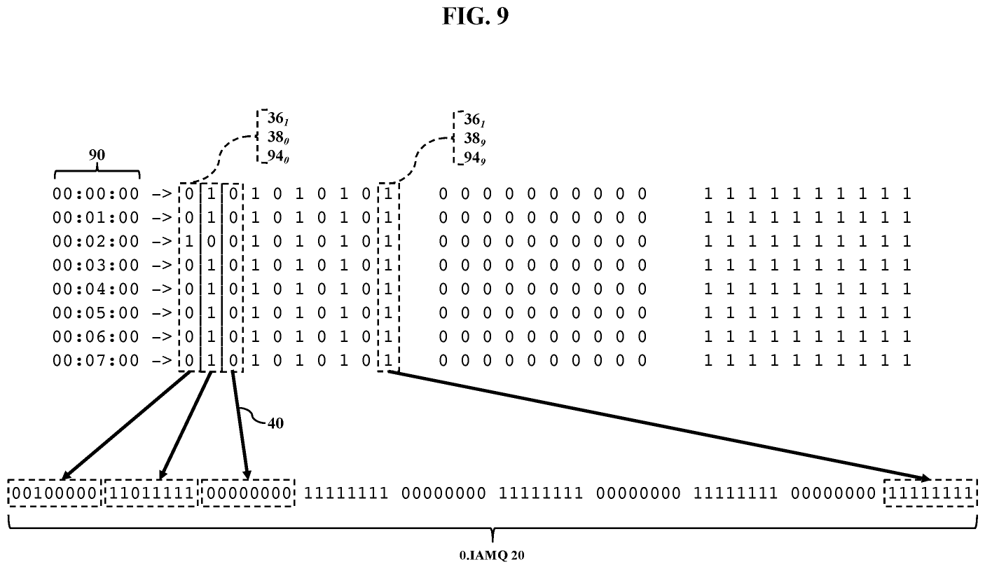

FIG. 9 thus illustrates the interwoven Bloom filters 36. The interwoven AMQ (or Lyons) data structure 20 is generated by interweaving the bits 38 from different AMQ data structures (again illustrated as the Bloom filters 36). While any interweaving bit (or byte) scheme may be used to generate the interwoven AMQ data structure 20, FIG. 9 illustrates interweaving according to the bit position 94. FIG. 9, for example, illustrates a first version of the interwoven AMQ data structure (illustrated as 0.IAMQ 20) generated by reading, copying, and aggregating the bits 38 according to the bit position 94. Each bit 380 (at the first index or bit position 940) is read from the first Bloom filters 361 generated at each interval of time t (illustrated as reference numeral 90). These bits 380 (at the first index or bit position 940) are copied, grouped together in a series, and written as an entry to the interwoven AMQ data structure 20. Similarly, the bits 38/(at the second index or bit position 941) are copied, grouped together in a chronological series, and written as another entry to the interwoven AMQ data structure 20. The bits 382 (at the second index or bit position 942) are copied, grouped together in a chronological series, and written as another entry to the interwoven AMQ data structure 20. The examples may continue interweaving the bits 38 and writing additional entries to the interwoven AMQ data structure 20. In FIG. 9, the examples write a final entry in the interwoven AMQ data structure 20 that interweaves the bits 389 (at the tenth index or bit position 949). The interwoven AMQ data structure 20 (e.g., 0.IAMQ) may thus contain the first 10 bits from each time unit, ordered by index/column first. The interwoven AMQ data structure 20 may thus be a single file that contains a complete and composite filter/bit representation of all the bit-set Bloom filters 36 captured at N=0 over the total time T=8 minutes.

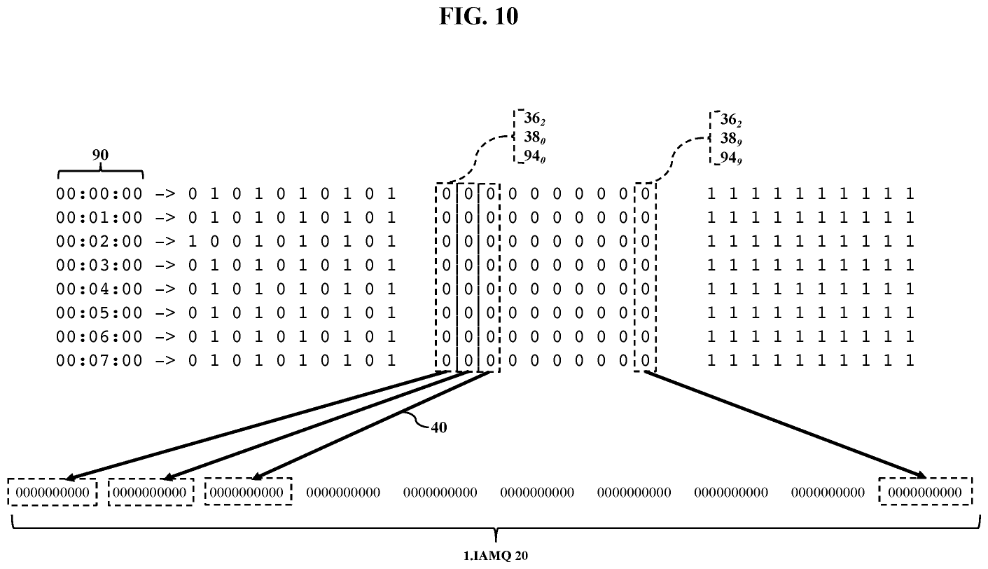

FIG. 10 illustrates another example of the interwoven AMQ (or Lyons) data structure 20. This second version of the interwoven AMQ data structure 20 is generated by interweaving the bits 38 from the Bloom filters 36 captured at N=1 over the total time T=8 minutes. Again, while any interweaving bit (or byte) scheme may be used, FIG. 10 starts at the first index (bit position 940) and interweaves according to the bit position 94. The server 24 (illustrated in FIGS. 1-4) reads, copies, and/or aggregates the bits 38 according to the bit position 94. Each bit 380 (at the first index or bit position 940) is read from the first Bloom filters 36 generated at each interval of time 1 (illustrated as reference numeral 90). These bits 380 (at the first index or bit position 940) are copied, grouped together in a series, and written as an entry to the interwoven AMQ data structure 20. Similarly, the bits 38/(at the second index or bit position 941) are copied, grouped together in a chronological series, and written as another entry to the interwoven AMQ data structure 20. The bits 382 (at the second index or bit position 942) are copied, grouped together in a chronological series, and written as another entry to the interwoven AMQ data structure 20. The examples may continue interweaving the bits 38 and writing additional entries to the interwoven AMQ data structure 20. The interwoven AMQ data structure 20 (e.g., 1.IAMQ) contains the first 10 bits from each time unit, ordered by index/column first. The interwoven AMQ data structure 20 may thus be a single file that contains a complete and composite filter/bit representation of all the bit-set Bloom filters 36 captured at N=1 over the total time T=8 minutes.

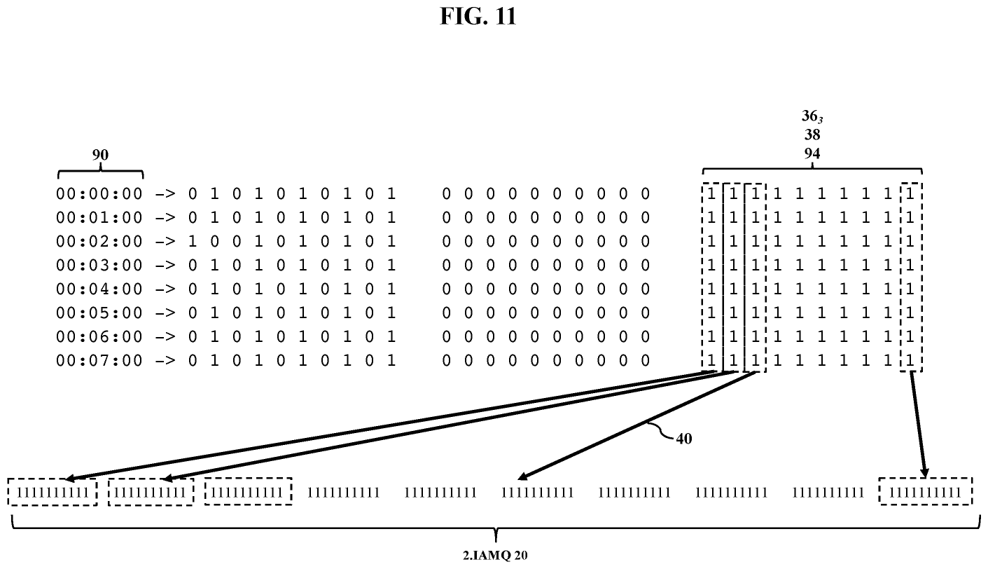

FIG. 11 illustrates yet another example of the interwoven AMQ (or Lyons) data structure 20. This third version of the interwoven AMQ data structure 20 is generated by interweaving the bits 38 from the Bloom filters 36 captured at N=2 over the total time T=8 minutes. Again, while any interweaving bit (or byte) scheme may be used, FIG. 11 starts at the first index (bit position 940) and interweaves according to the bit position 94. The interwoven AMQ data structure 20 (e.g., 2.IAMQ) contains the first 10 bits from each time unit, ordered by index/column first. The interwoven AMQ (or Lyons) data structure 20 may thus be a single file that contains a complete and composite filter/bit representation of all the Bloom filters 36 captured at N=2 over the total time T=8 minutes.

The interwoven AMQ data structure 20 collapses the Bloom filters 36. The interwoven AMQ data structure 20 combines and interweaves the multiple Bloom filters 36_{1-N}, but the interwoven AMQ data structure 20 may arrange the bits 38 in time series as opposed to bit series. The bit 38a, at a specified bit position 94 within Bloom filter 38a, is arranged next to the bit 38b read from the same specified bit position 94 within Bloom filter 38b. If this collapsing is repeated over 24 times x 60 minutes, the hardware processor 36 would read 1,440 bits (or 180 bytes) a maximum of k times. While k may be any value, a value of k=6 is often sufficient. A bitmask AND operation is performed across the read values of k (e.g., Read₀&& Read₁&& . . . && Readₖ), thus allowing a simple bit inspection. Where any bit is set to logical 1, then that key 72 was probably seen at that time offset. So, after collapsing all of those k Bloom filters 36, the basic result is a picture of which minutes would this key 72 possibly have occurred. The examples thus narrow down a lookup search of the computer database 54 to those specific minutes.

Yet another membership example is provided using the interwoven AMQ data structure 20. Suppose the Bloom filters 36 use k=3 hashes, and for a key abcd:cdef the hashN function gives us 0.IAMQ and the Bloom hashes give indices 0, 3, and 5 In order to check which minutes the key 72 (e.g., abcd:cdef) may have been seen, the examples may first open the 0.IAMQ (illustrated in FIG. 9). The server 24 may read chunks of the bits 38 equivalent to T/t. In this example, this is 0:8, 24:32, and 40:48. Using bit AND operations, these bit chunks correspond to
00100000 AND 11111111 AND 11111111=00100000.
   Here, the bit 38 at index 2 (e.g., bit position 3) is flipped on (or logical/binary 1) for all k=3 chunks. This means that the only time the key 72 may be present is minute 2.

The interweave operation 40 (illustrated in FIGS. 1 & 9-11) thus breaks up each Bloom filter 36. Each Bloom filter 36 may be broken up into its individual bit portions. The corresponding bits 38 from each Bloom filter 36, associated with the same bit position 94, may be combined, interweaved, and/or positioned next to each other, perhaps according to consecutive Bloom filter time, numbering, or other order. Interweaving, in other words, is akin to straws of hay bales being combined together. Interleaving, on the other hand, stacks individual Bloom leaves on top of each other. Interleaving implies that there are distinct sections of the Bloom filter that are placed next to each other. Interweaving breaks up the entire Bloom filter 36 into its individual bit portions, and then those bits are combined next to each other with bits at common bit positions read from other Bloom filters.

The examples further improve computer functioning. Long-term storage of data benefits from Bloom filters which indicate where the key 72 is present within time ordered sets of data and to be able to query efficiently. For example, in the last 90 days, which minutes contain the data for key abcd:cdef. If data is stored in a time-based way, then a time-series Bloom filter provides insight into where data is stored and helps in efficient data retrieval. A time-series Bloom filter can be used to identify if a key 72 has been seen recently, and therefore which data store to query (e.g., last hour, last day, or 30 days ago). If data is expected to be infrequently accessed or possibly never accessed, then such data can be saved to a cheaper storage service. Such a storage service is cost effective if the number of reads performed are relatively few. The examples organize the bit/byte data in such a way as to minimize reads and file loads. The examples easily scale for large, long-term storage of data and provide time granularity. The examples eliminate individually and costly checking multiple Bloom filters. The examples may thus may not only save Bloom filters on a time basis, but the examples also interweave multiple Bloom filters together in such a way as to minimize the number of disk reads and memory allocations required to check if a key 72 exists and when that key 72 may have been seen.

Still another example is provided. Suppose t=1 minute, T=24 hours, n=4096 bits, N=2048, and k=6. For 800,000 keys per minute (hashed evenly), the odds of a false positive are approximately 0.69%. Each minute would contain approximately 1 MB of Bloom filters. The number of aggregate files would be 2048 for a given day. Each would be approximately 1.4 MB in size and sum to 2.81 GB total. A key 72 could be hashed with SHA-1 once and the bits used to represent between 0 and 2048 once and 0 to 4096, six more times. One interwoven AMQ (or Lyons) data structure 20 would be opened and up to 6 reads would occur, each totaling 1440 bits or 180 bytes. Fewer than 6 reads may occur if the AND combination of reads equals all 0s within <6 reads.

The interwoven AMQ data structure 20 may thus be one file for an entire window. Again using a per minute example, there would be 1,440 Bloom filters collapsed and co-located within the single interwoven AMQ data structure 20. Moreover, rather than merely sequentially writing the 1,440 Bloom filters, the examples interweave the 1,440 Bloom filters based on the bits 94 of interest. The first 24 by 60 bits, for example, is the first bit 380 of every Bloom filter 36 using bitwise AND operation. Then the next 24 by 60 bits is the second bit 38₁ of every filter 36. The next 24 by 60 bits is the third bit 38₂ of every filter 36, and so on. Because when looking up for a filter, the examples need only look up those bits 38 that are to be found. So, if looking across 24 by 60 filters, the interwoven AMQ data structure 20 locates all those bits 38 next to each other, so only one read operation need be performed to get that bit 38 across every filter 36.

The interweave operation 40 greatly improves computer functioning. The interweave operation 40 co-locates bit/byte data read from AMQ filters using bit operations. Because the interwoven AMQ data structure 20 merges and collapses a large number of the AMQ filters (such as the Bloom filters 36), the interwoven AMQ data structure 20 greatly reduces the number of read/writes proportional to the number of filters used. By combining the multiple Bloom filters 36, for example, only k reads of the interwoven AMQ data structure 20 are needed. Conventional schemes would read k times the number of individual Bloom filters 38. Examples reduce the number of lookups for a large number of filters by orders of magnitude. For example, if a Bloom filter 36 is generated for every minute of the day, then the interwoven AMQ data structure 20 reduces the number of reads, the number of memory allocations, the number of CPU cycles, the number of I/O operations, and the number of translations from kernel space to user space.

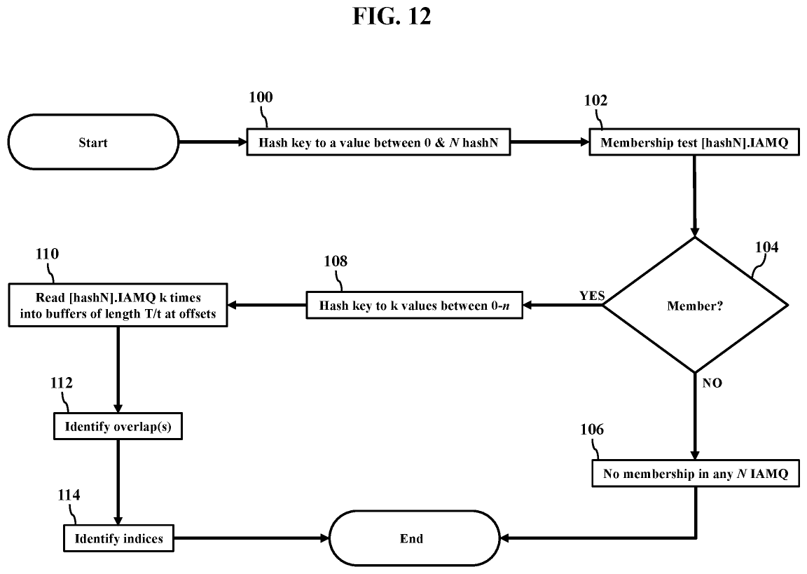

FIG. 12 illustrates a method or flowchart for looking up the key 72. The key 72 is hashed to a value between 0 and N hashN (Block 100). The [hashN].IAMQ 20 is opened and membership tested (Block 102). If the key 72 is not a member (Block 104), then the key 72 is not a member of any N IAMQ 20 (Block 106). If, however, the key 72 is a member of the [hashN].IAMQ 20 (Block 104), then the key 72 is hashed to k values between 0 and n (Block 108), where k is the number of hash functions for a Bloom filter 36 of length bit length n (e.g., hashK1, hashK2 . . . hashKk). The [hashN].IAMQ 20 is read k times into buffers of length T/t at offsets (hashK1*T/t),(hashK2*T/t) . . . and (hashKk*T/t) (Block 110). A binary AND operation is performed across all buffers to find where any overlap occurs (Block 112). After all, if an AND operation yields all 0s at any point between 0-k, then the remaining reads may be skipped. In other words, once an AND operation yields all 0s, further AND operations will always yield 0. Any remaining bit indices indicate which time units the key 72 is seen (Block 114).

The interwoven AMQ (or Lyons) data structure 20 thus allows a single, simultaneous lookup of the multiple Bloom filters 36. In order to look up the key 72, the key 72 may be hashed to some number of values (typically referred to as k values between 1 and K). These individual k values may then be looked up in the single interwoven AMQ data structure 20 that represents a composite membership filter or bit traits of the multiple Bloom filters 36. Because the interwoven AMQ data structure 20 interweaves and co-locates the bits 38 of the multiple Bloom filters 36, a single simultaneous lookup of the relevant bits is performed in one sweep per hash, per k value. So, in real numbers, normally the hash for the Bloom filter 36 is converted into six numbers, so six conventional checks are performed in each Bloom filter 36. Again using a per minute example, there would be 1,440 Bloom filters, and each Bloom filter would conventionally be read six (6) times (meaning 8,640 conventional lookups). However, by aggregating and interweaving the 1,440 Bloom filters into the single interwoven AMQ data structure 20, only six (6) total lookups are needed. The interwoven AMQ data structure 20 thus requires orders of magnitude less reads, processor operations, memory, and kernel translations.

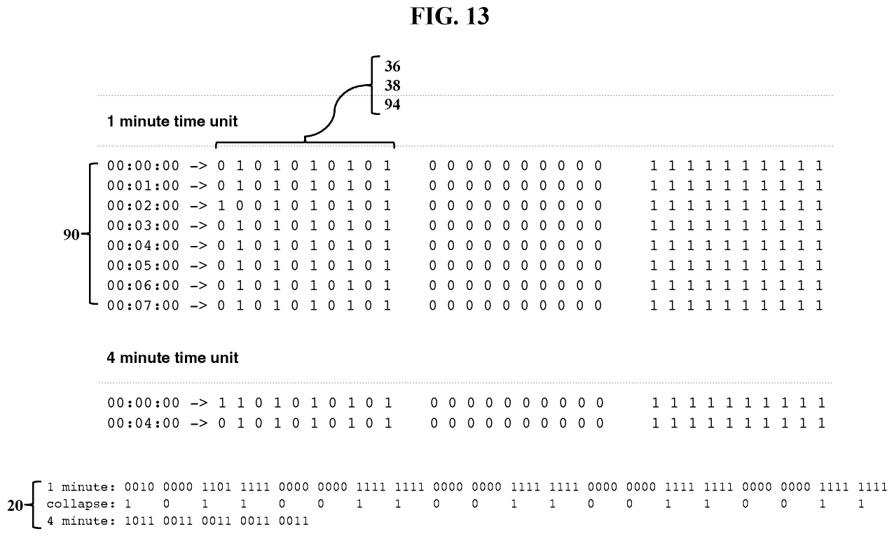

FIG. 13 illustrates examples of layering of filters. Any AMQ data structures (again illustrated as the Bloom filters 36) may be layered to form long term and short term views, e.g., time units in minutes/hours/days. Given an interwoven AMQ (or Lyons) data structure 20 with one minute time units, a new interwoven AMQ data structure 20 may be formed on an hourly basis by collapsing the file n bits at a time (perhaps using an OR operator). As FIG. 13 illustrates, suppose the interweave operation 40 creates a second .IAMQ 20 based on 4 minute increments. The four minute .IAMQ 20 can be used first, and the one minute .IAMQ 20 to further narrow the scope. In actual practice though, these time schemes would be closer to month/day/hour/minute for larger datasets.

Sharding may also be used. For any file-backed filter, regardless of the type the AMQ filter, the file-backed filter may be split into multiple distinct files or shards. Each shard would essentially be an independent filter. In order to insert an element into the set of sharded filters, the element would be passed through a deterministic hash to resolve which shard should be used. The element can then be inserted to that single filter shard using the mechanisms defined by the filter type. To check if the element is a member of a sharded filter set, the deterministic hash is repeated to resolve which shard to inspect. The examples then use the filter as normal to check inclusion. Suppose, for example, that each Bloom filter is 10 MB/minute. Over 60 minutes, then, examples may interweave those separate Blooms 361-60 as the single interwoven AMQ (or Lyons) data structure 20 having a 600 MB size. The software application 28 may further cause the computer system 22 to perform a sharding operation that breaks up that 600 MB interwoven AMQ data structure 20. The software application 28 may generate smaller Bloom filters 36 than 10 MB/minute using smaller time intervals. For example, instead of using a 10 MB Bloom filter, the examples may use 1 MB Bloom filters as different shards. When any search element (such as the key 72) is received, its corresponding hash value may be used to determine which Bloom shard to which it belongs. The examples may then inspect the time-series Bloom filter 36 of that shard. Suppose there are ten (10) time-series Bloom filters, and they all cover the same 60 minutes, but they cover different subsets of elements. When the search element is received, its hash value determines which of those (10) time-series Bloom filters is the Bloom filter responsible for the element. The bitwise operations may be performed against just that interwoven AMQ data structure 20. And so, the reason to do that is that the smaller Bloom filters may be used because they have less elements in them. So, if ten (10) Bloom filters are used, each Bloom filter may use one-tenth the size for each shard or each sub-filter. Put another way, if a lot of data is inserted into a Bloom filter, then that Bloom filter needs to be very large. More data may be inserted into a 100 MB Bloom filter than a 5 MB Bloom filter. So, if the 5 MB Bloom filter is used, but a 100-megabyte Bloom filter's worth of data is required, the interweave operation 40 may use twenty (20) individual Bloom filters of 5 MB each. Before data is inserted, examples may determine which of those twenty (20) Bloom filters is associated with the hash of the element to be inserted. Once the correct 5 MB Bloom filter is identified, the k hashes may be performed to check the individual bits of that Bloom filter. The sharding examples thus provide optimizations when using a large time-series or a large number of elements. These situations may cause the interwoven AMQ data structure 20 grow large, perhaps by a factor of however many time windows are being used. Using 1-minute intervals over one hour (e.g., 60×60), this windowing leads to very large file sizes. The examples mitigate large file sizes, which further helps with optimizing file transfer protocols.

Pre-fixing may be used. Any interwoven AMQ data structure 20 may set a prefix of the n bits 38 that represent a Bloom filter 36 that is the result of every unit filter combined. This prefix can first be read into the memory device 30 and checked prior to checking all subsequent bit positions 94. This results in a minimum of 1 read per lookup and a maximum of k+1 reads.

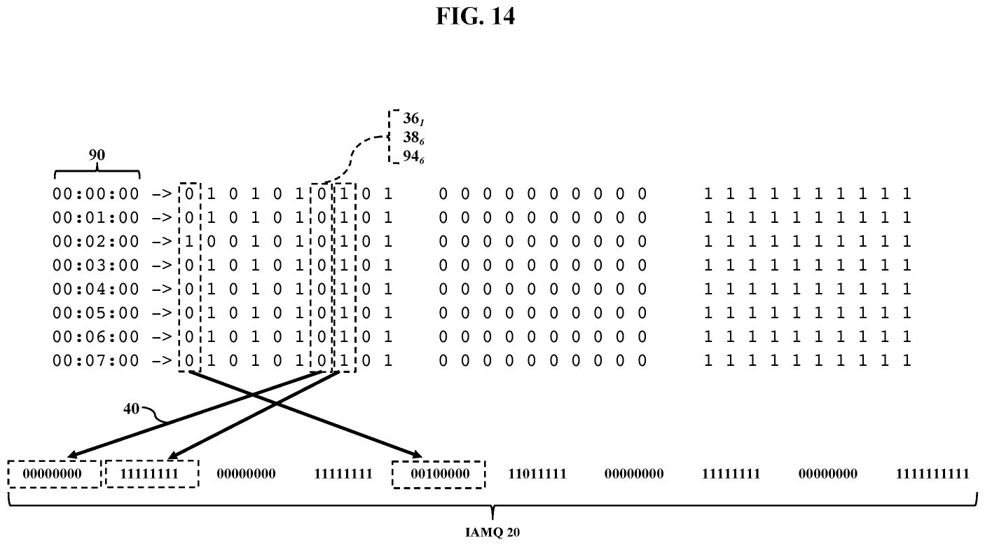

FIG. 14 illustrates more examples of interwoven AMQ data structures (again illustrated as the Bloom filters 36). The interweave operation 40 may be programmed to randomly or particularly identify, read, and interweave any bits 38 from any bit positions 94. In FIG. 14, for example, the interwoven AMQ (or IAMQ) data structure 20 is generated by starting at bit position 6 (illustrated as reference numeral 946) and reading these positional bits across the time-series from each Bloom filter 36. The interweave operation 40 may then sequentially identify, read, aggregate, and interweave the bits 38 from bit positions 7, 8, and 9. The interweave operation 40 may then return and sequentially identify, read, and interweave the bits 38 from bit positions 0-5 from each Bloom filter 36. The interweave operation 40 may thus be programmed to start from any bit 38 at any bit position 94 that suits some performance objective.

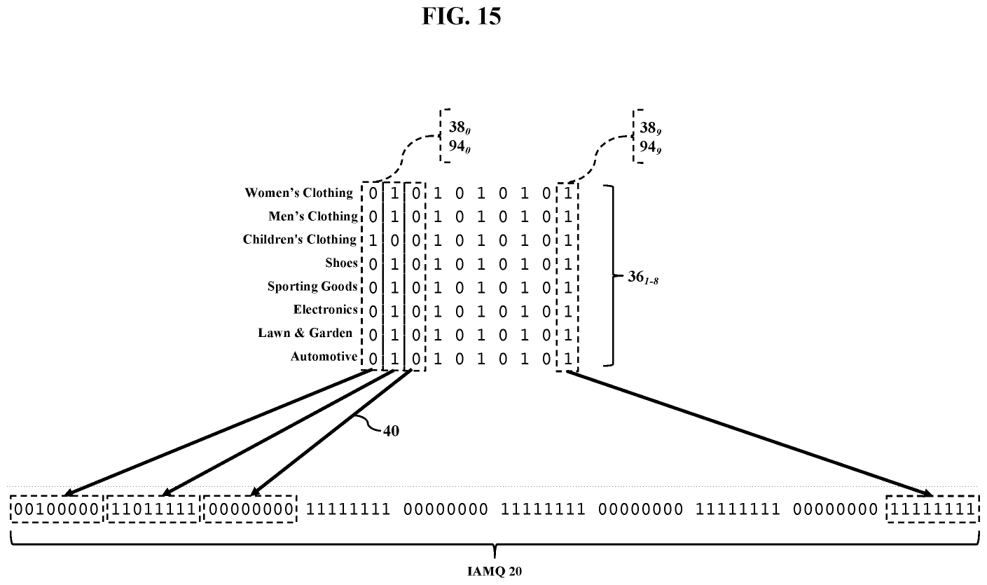

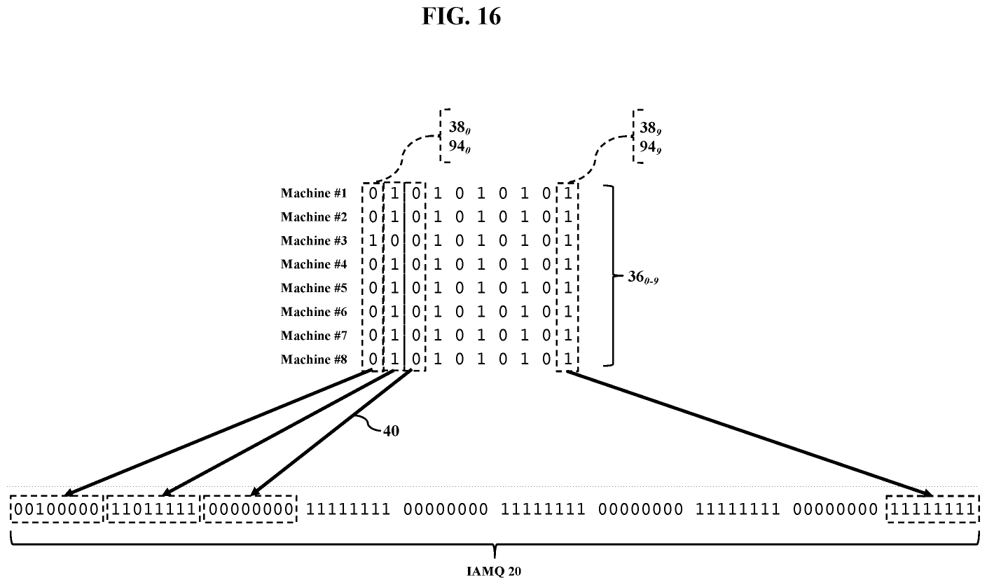

FIGS. 15-16 illustrate examples of untimed interwoven Bloom filters 36. Here the interwoven AMQ (or IAMQ) data structures (again illustrated as the Bloom filters 36) need not be time-based. FIG. 15, for example, illustrates the Bloom filters 36 representing membership associated with different retail departments. FIG. 16 illustrates the Bloom filters 36 representing membership associated with different manufacturing machines. The interwoven AMQ data structure 20 may thus be generated by interweaving different Bloom filters 36, regardless of time. Bits 38 may be randomly, and/or particularly, identified and read from different Bloom filters 36 and interweaved as desired. The interweave operation 40 may thus be programmed to start from any bit 38 at any bit position 94, from any Bloom filter 36, that suits some performance objective.

As FIGS. 15-16 illustrate, the interweave operation 40 may be applied to any bit-setting AMQ data structures. The bits 38 at the bit positions 94 may be mapped to any arbitrary data. While time (such as reference numeral 90 illustrated in FIGS. 6-11) is perhaps most common, the interweave operation 40 may merge and interweave any Bloom filters 36 representing any criterion (such as the above departments and machines). The interweave operation 40 aggregates any AMQ bit-set filters representing data across different scopes. That scope may be time-based, or the scope may be any other category. Because the interweave operation 40 aggregates multiple filters from distinct scopes, the interwoven AMQ (or Lyons) data structure 20 allows a single query to be performed across all the multiple filters.

The examples may interweave any approximate membership query (or AMQ) data sets. While there are many different types of AMQ data sets that implement bit-setting operations, the examples are described using the Bloom filters 36. Because Bloom filters are known examples of AMQ data structures, this disclosure need not provide a detailed explanation. A Bloom filter is a space-efficient probabilistic data structure that is used to test whether an element is a member of a set. An empty Bloom filter is a bit array of bits, with all the bits set to 0. There must also be k different hash functions defined, each of which maps or hashes some set element to one of the bit array positions. To add an element, feed it to each of the k hash functions to get k array bit positions. Set the bits at all these bit positions to 1. To query for an element (test whether it is in the set), feed it to each of the k hash functions to get k array bit positions. If any of the bits at these positions is 0, the element is definitely not in the set; if it were, then all the bits would have been set to 1 when it was inserted. If all are 1, then either the element is in the set, or the bits have by chance been set to 1 during the insertion of other elements, resulting in a false positive. More details of the Bloom filters 36 may be found in U.S. Pat. No. 8,260,910 to Schuba, et al., in U.S. Pat. No. 8,468,134 to McHugh, et al., in U.S. Pat. No. 9,842,132 to McKenna, et al., and in U.S. Pat. No. 11,494,358 to Prasad Abhinav, with all these patents incorporated herein by reference in their entireties.

The examples thus describe methods, computer software, computer systems, and computer program products that reduce search times and unnecessary accesses to memory when determining whether a given item is present in a memory. Multiple AMQ data structures (such as the Bloom filters 36) are ingeniously interwoven to generate the compact and nimble interwoven AMQ (or Lyons) data structure 20. The examples collapse and co-locate the multiple AMQ data structures (such as the Bloom filters 36) into a single filter/bit membership representation. The examples organize the bit/byte data in such a way as to minimize reads and file loads. The interwoven AMQ data structure 20 eliminates individually and costly checking the multiple Bloom filters 36. The examples thus minimize the number of disk reads and memory allocations when membership testing. The examples thus have many benefits, such as smaller memory requirements, faster searching of data, and more compact, effective storage of data.

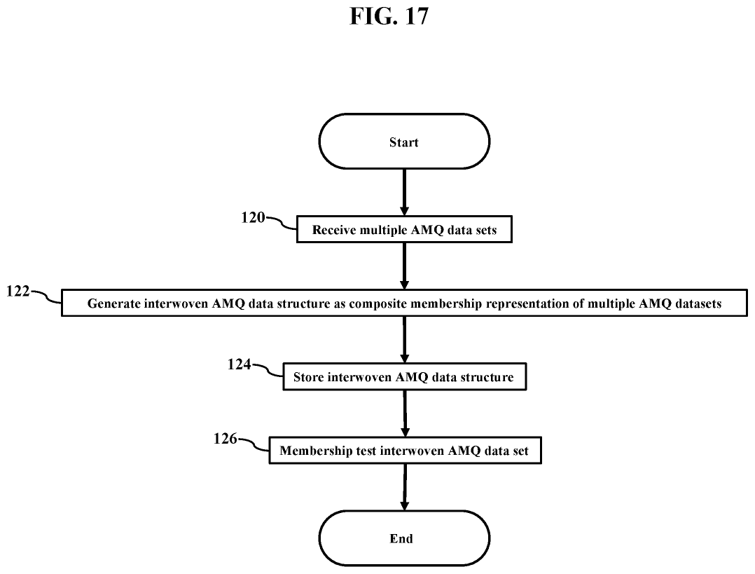

FIG. 17 illustrates examples of a method or operations that improves computer functioning using the interwoven AMQ data structure 20. The multiple approximate membership query (or AMQ) data sets 34a-b are received (Block 120). The interwoven AMQ data structure 20 is generated as a composite membership representation of the multiple AMQ datasets 34a-b (Block 122). The interwoven AMQ data structure is stored to improve the computer functioning by consuming less of the memory device 30 (Block 124). The interwoven AMQ data structure may be membership tested to further to improve the computer functioning (Block 126).

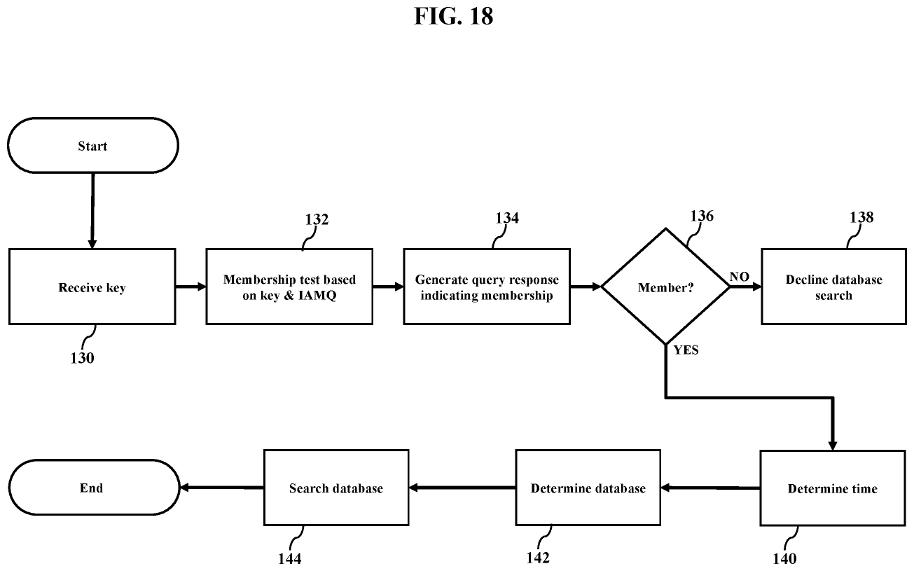

FIG. 18 illustrates more examples of a method or operations for determining a membership associated with the interwoven AMQ data structure (or IAMQ) 20. The key 72 is received (Block 130) and the membership test 56 is performed based on the key 72 and the interwoven AMQ data structure 20 that interweaves the bits 38a-b associated with the multiple Bloom filters 36a-b (Block 132). The query response 74 is generated and indicates the membership associated with the key 72 and the interwoven AMQ data structure 20 (Block 134). If the membership test 56 fails or is negative (Block 136), then the computer 22 declines to search the computer database 54 (Block 138). If the membership test 56 is positive or successful (Block 136), then the computer 22 determines a time associated with the interwoven AMQ data structure 20 and/or any of the Bloom filters 36a-b (Block 140) and determines the computer database 54 that is associated with the interwoven AMQ data structure 20 (Block 142). The computer 22 searches the computer database 54 (Block 144).

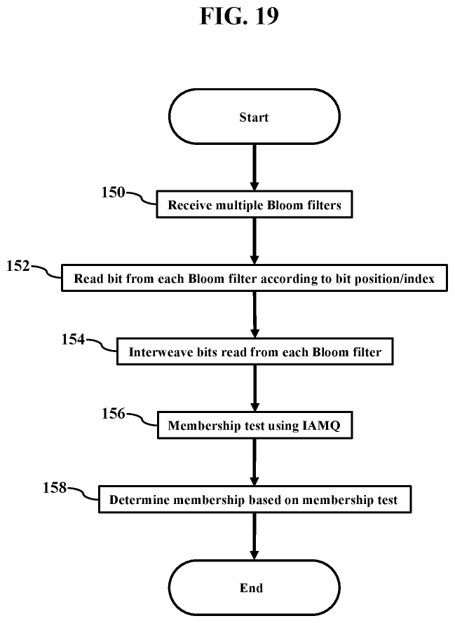

FIG. 19 illustrates still more examples of a method or operations for determining a membership associated with the key 72. The multiple Bloom filters 36a-b are received (Block 150). A bit 38 of the n bits from each Bloom filter 36 that corresponds to each bit position 0, 1, 2, . . . , n is read (Block 152). The interwoven AMQ data structure (or IAMQ) 20 is generated by interweaving the bits 38 read from each Bloom filter 36 (Block 154). The key 72 (or its associated hash value) is membership tested based on the interwoven AMQ data structure 20 (Block 156). The membership is determined (Block 158).

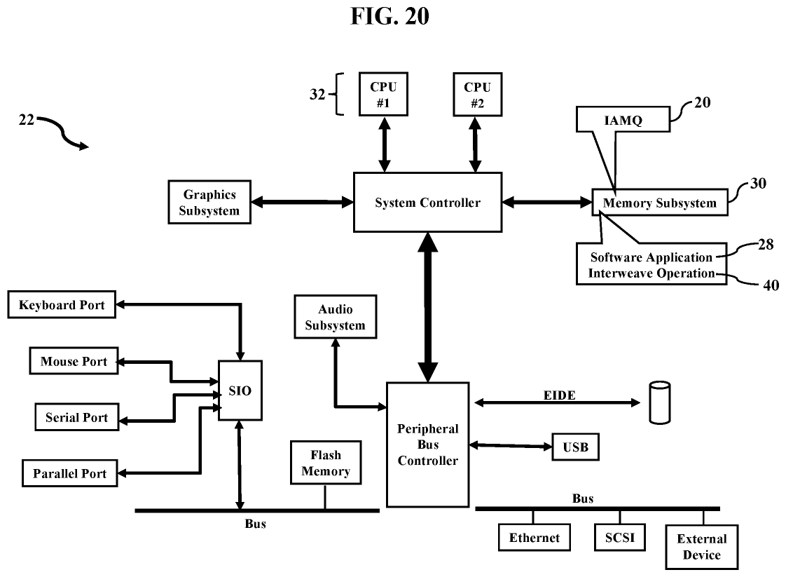

FIG. 20 illustrates a more detailed example of the operating environment. FIG. 20 is a more detailed block diagram illustrating the computer system 22. The software application 28, implementing the interweave operation 40, is stored in the memory subsystem or device 30. One or more of the processors 32 communicate with the memory subsystem or device 30 and execute the software application 28. Examples of the memory subsystem or device 30 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 22 is known to those of ordinary skill in the art, no detailed explanation is needed.

The computer system 22 may have any embodiment. As this disclosure explains, the computer system 22 may be embodied as the server 24. The computer system 22, though, may be embodied as any component of the cloud computing environment 62, such as a switch, a router, a storage component, and/or a management component. The computer system 22 may also be embodied as a smartphone, a laptop/tablet computer, a smartwatch, a television, an audio device, a remote control, and/or a recorder. The computer system 22 may also be embodied as a smart appliance, such as washers, dryers, and refrigerators. Indeed, as cars, trucks, and other vehicles grow in electronic usage and in processing power, the software application 28, implementing the interweave operation 40, may be easily incorporated into any vehicular controller.

The above examples of interwoven AMQ data structures may be applied regardless of the networking environment. The software application 28, implementing the interweave operation 40, may be easily adapted to execute in stationary or mobile devices having wide-area networking (e.g., 4G/LTE/5G cellular), wireless local area networking (WI-FI®), near field, and/or BLUETOOTH® capability. The software application 28, implementing the interweave operation 40, may be applied to stationary or mobile devices utilizing any portion of the electromagnetic spectrum and any signaling standard (such as the IEEE 802 family of standards, GSM/CDMA/TDMA or any cellular standard, and/or the ISM band). The software application 28, implementing the interweave operation 40, however, may be applied to any processor-controlled device operating in the radio-frequency domain and/or the Internet Protocol (IP) domain. The examples may be applied to any processor-controlled device utilizing a distributed computing network, such as the Internet (sometimes alternatively known as the “World Wide Web”), an intranet, a local-area network (LAN), and/or a wide-area network (WAN). The examples may be applied to any processor-controlled device utilizing power line technologies, in which signals are communicated via electrical wiring. Indeed, the many examples may be applied regardless of physical componentry, physical configuration, or communications standard(s).

The computer system 22 may utilize any processing component, configuration, or system. For example, the examples may be easily adapted to any desktop, mobile, or server central processing unit, graphics processor, ASIC, or chipset offered by INTEL®, ADVANCED MICRO DEVICES®, ARM®, APPLE″, TAIWAN SEMICONDUCTOR MANUFACTURING®, QUALCOMM®, or any other manufacturer. The computer system 22 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The examples may inspect packetized communications. When the computer system 22 communicates via any communications network, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The examples may utilize any signaling standard. The cloud computing environment 62, for example, may mostly use wired networks to interconnect the network members 60. However, the cloud computing environment 62 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 62 may also utilize other standards, such as the I.E.E.E. 802 family of standards, the Industrial, Scientific, and Medical band of the electromagnetic spectrum, BLUETOOTH®, low-power or near-field, and any other standard or value.

The software application 28, implementing the interweave operation 40, may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for generating and/or searching interwoven AMQ data structures, as the above paragraphs explain.

The diagrams, schematics, illustrations, and the like represent conceptual views or processes illustrating examples of interwoven AMQ data structures. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer that improves computer functioning, comprising:
receiving, by the computer, multiple approximate membership query (AMQ) data sets;
generating, by the computer, an interwoven composite membership representation of the multiple AMQ data sets; and
storing, by the computer, the interwoven composite membership representation in a memory device;
wherein the interwoven composite membership representation improves the computer functioning by reducing reads of the memory device.

2. The method of claim 1, wherein the generating of the interwoven composite membership representation further comprises interweaving bits associated with the multiple AMQ data sets.

3. The method of claim 1, wherein the generating of the interwoven composite membership representation further comprises interweaving bits associated with different AMQ data sets of the multiple AMQ data sets.

4. The method of claim 1, wherein the generating of the interwoven composite membership representation further comprises interweaving at least one bit associated with each AMQ data set of the multiple AMQ data sets.

5. The method of claim 1, wherein the generating of the interwoven composite membership representation further comprises interweaving bits associated with the multiple AMQ data sets according to bit position.

6. The method of claim 1, wherein the generating of the interwoven composite membership representation further comprises interweaving bits associated with different AMQ data sets of the multiple AMQ data sets according to bit position.

7. The method of claim 1, wherein the generating of the interwoven composite membership representation further comprises co-locating bits associated with different AMQ data sets of the multiple AMQ data sets.

8. The method of claim 1, further comprising determining a membership associated with the interwoven composite membership representation.

9-20. (canceled)
